(19) United States
(12) Patent Application Publication
(10) Pub. No.: US 2008/0210308 A1
(43) Pub. Date: Sep. 4, 2008

(54) Method and Structure for Retaining a Tube

(76) Inventors: John Michael Dooley, Chesterfield, MI (US); Kevin John Hartle, West Midlands (GB)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 10/588,465

(22) PCT Filed: Feb. 2, 2005
(86) PCT No.: PCT/GB05/00342

§ 371 Date: May 6, 2008

(30) Foreign Application Priority Data
Feb. 2, 2004 (GB) 0402206.7

(51) Int. Cl. F16L 41/14; F16L 5/02; B23P 11/00; B21B 1/00

(52) U.S. Cl. 137/15.01; 285/192; 29/592; 72/362; 72/199; 83/13

(57) ABSTRACT

A method and structure for retaining a tube in place relative to a surface of a device, such as a motor or pump, for fluid communication there-between. The tube retainer comprises a tube having a retention groove, disposed adjacent an open end thereof, and a holding clamp having a slot which is engageable with the retention groove. The holding clamp further comprises a bolt hole for receiving a threaded bolt for engaging a threaded bore in the device to attach the holding clamp thereto, thereby holding and retaining the tube relative to the surface of the device.

The present invention relates to a method and structure for holding and retaining a tube in place relative to a surface.

It is often desirable to hold and retain a tube or pipe to a surface. For example, this is particularly desirable where a tube or pipe extends into, or from, a device, such as for example, a pump or motor etc.

For the benefit of clarity the terms tube and pipe should be understood to be interchangeable in this specification.

A known method and structure of holding and retaining a tube is shown in FIG. 1, wherein a collar fitting 2, having a shoulder 4, is brazed onto a tube 6. A stamped metal holding clamp 8, which is attachable to a surface, is shaped to be engageable with the shoulder 4 to thereby hold and retain the tube 6 relative to the said surface.

An alternative known method and structure is shown in FIG. 2 wherein instead of the shoulder being formed on a collar as in FIG. 1, the shoulder 4 is cold formed in the tube 6. A similar holding clamp is used to hold and retain the tube relative to a surface as described in the previous paragraph.

These known methods and structures are generally used to hold and retain tubes, which contain a fluid. Also, such tubes extend into, and out of, devices such as pumps and motors, wherein a seal, such as an O ring, is used to prevent leakage of the fluid at the tube-device interface.

However, these known methods are disadvantaged in that the formation of the seal and the means for holding and retaining the tube requires two separate manufacturing steps. Therefore, the structure is relatively expensive to make. Furthermore, these known structures allow the tube to rotate within the clamp. It is therefore desirable for there to be a method and structure, for holding and retaining a tube, which is relatively simple and inexpensive to manufacture. It is also desirable for there to be such a method and structure which provides improved holding and retaining of a tube relative to a surface.

According to the present invention there is provided a tube retainer comprising a tube having a retention groove formed in the external surface, adjacent to an open end, of said tube, and a holding clamp adapted to engage said retention groove.

The retention groove may be annular and may be formed around at least part of the external surface of the said tube.

The holding clamp may be a flat plate having a slot formed therein for engaging said retention groove. The slot may be open ended.

The tube may further comprise a second groove, formed in the external surface of the tube, adapted to receive sealing means, such as, for example, an O ring. The second groove may be formed in the tube between the retention groove and the end of said tube.

According to a second aspect of the present invention there is provided a method of manufacturing a tube retainer as claimed in claim 1, comprises the steps of: providing a tube; forming a retention groove in the external surface of said tube, adjacent an open end thereof; providing a flat plate and forming a slot in said flat plate to form a clamping plate.

The method may further comprise the step of forming a second groove, suitable for receiving sealing means such as, for example, an O ring. The second groove may be formed the external surface of the tube between the retention groove and the adjacent open end of the tube.

At least one of the retention groove and second groove may be formed in the external surface by rolling a groove therein. Alternatively, at least one of the retention groove and second groove may be formed in the external surface by cutting a groove therein.

According to a third aspect of the present invention there is provided a method of retaining a method of retaining a tube to engage a device comprises the steps of: providing a tube; forming a retention groove adjacent an end of the tube; providing a flat plate: forming a slot in the plate to form a holding clamp; engaging said slot with said retention groove; and, attaching said holding clamp with the tube to the device.

The retention groove may be annular and may be formed at least around part of the external surface of the tube.

The method may further comprise forming a second groove, suitable for receiving sealing means, such as an O ring. The second groove may be formed between the retention groove and said end of the tube.

The present invention will now be described further with reference to the following drawings, in which:

FIG. 1 is a perspective view of a prior art tube retention structure;

FIG. 2 is a perspective view of a second prior art retention structure;

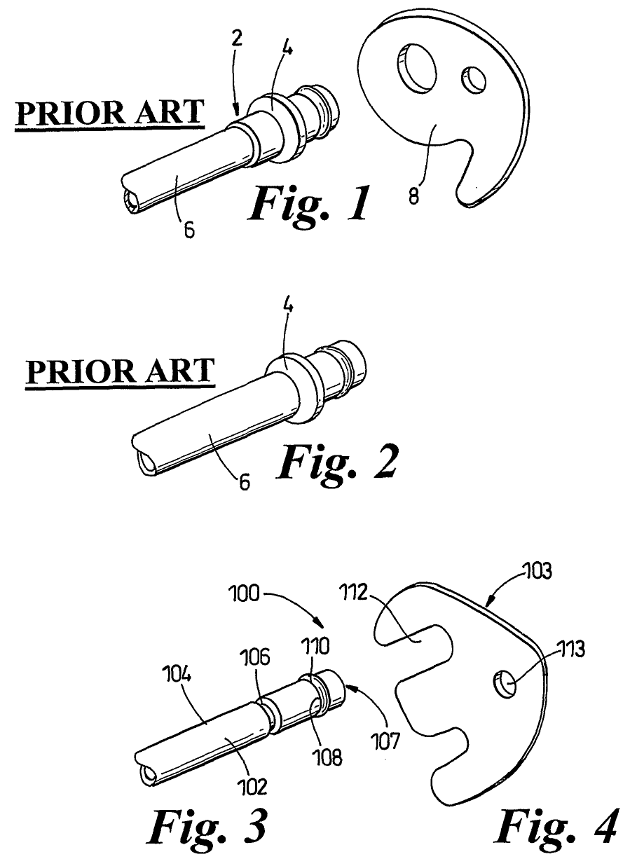

FIG. 3 is a perspective view of the tube structure according to the present invention;

FIG. 4 is a perspective view of a holding clamp according to the present invention;

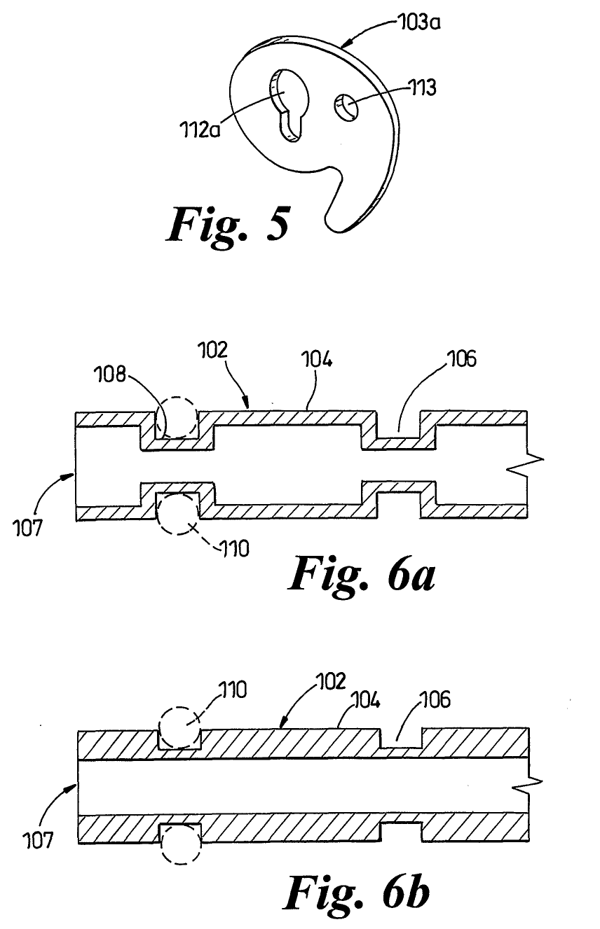

FIG. 5 is a perspective view of an alternative holding clamp according to the present invention;

FIG. 6 is a cross sectional view of the tube end with the retention groove and second seal groove;

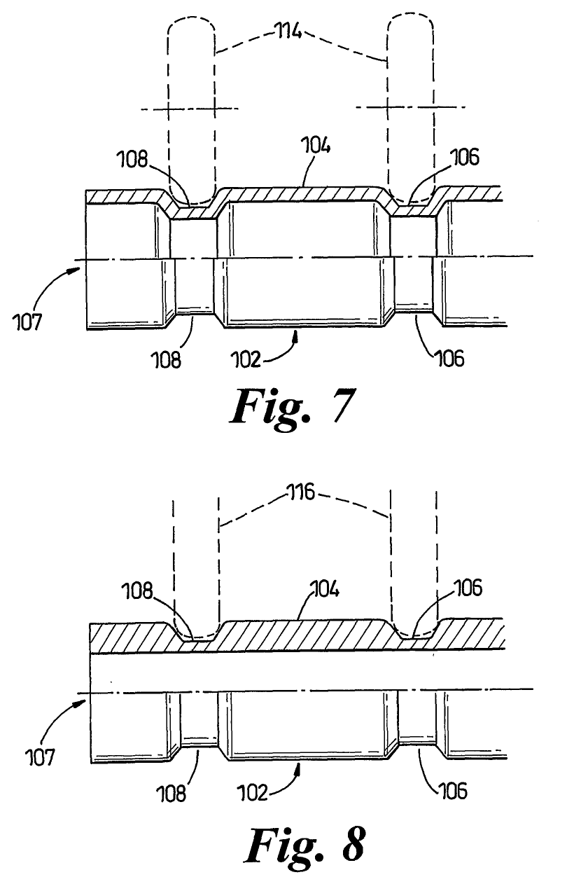

FIG. 7 is a cross sectional drawing showing a method of formation of the grooves in the tube according to the present invention;

FIG. 8 is a cross sectional drawing showing a second method of formation of the grooves in the tube according to the present invention; and,

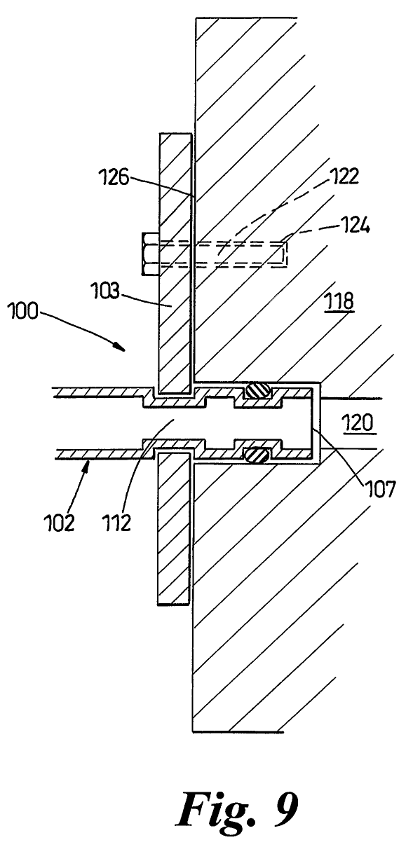

FIG. 9 is a cross sectional view of the tube retainer attached to a device.

Referring to FIG. 3, the present invention provides for a tube retainer 100 for retaining a tube relative to a surface on a device (not shown) such as a pump or motor. The tube retainer 100 comprises a tube 102 and a holding clamp 103.

The tube 102 has an external surface 104 in which there is formed an annular retention groove 106 adjacent an open end 107 thereof. However, it will be appreciated by the reader that the groove is not limited to being annular for the working of the invention. Instead, for example, the retention groove may be in the form of one or more flat portions formed in the external surface of the tube. This particular example may be advantageous if it desirable to prevent rotation of the tube relative to the holding clamp.

The tube further comprises a second groove 108 also formed in the external surface 104 of the tube 102. The second groove 108 is formed to receive sealing means such as an O ring 110 which forms a fluid seal between the tube and the device into which the tube extends.

Referring also to FIG. 4, the holding clamp 103 is formed from a stamped metal plate. A slot 112 is formed in the holding clamp 103 to engage the retention groove 106, of the tube 102. The slot 112 is an open mouthed slot which extends to open at the periphery of the holding clamp. An alternative holding clamp 103a, shown in FIG. 5, comprises a closed slot 112a having a diameter to receive the tube 102 and an extended portion of lesser diameter to engage the retention groove 106.

The holding clamps 103 and 103a further comprise a bolt hole 112, which may be threaded, for receiving a bolt (not shown) for bolting to the surface of a device. Of course, it will be appreciated by the reader that the holding clamp may be held against the surface by other means and the invention is equally workable therewith.

By way of engaging the retention groove 106, of the tube, and being bolted to the surface of a device, the holding clamp 103 retains and holds the tube relative to the surface of the device to provide a secure connection for fluid connection between the tube and the device.

Referring to FIG. 6a, the retention groove 106 and the second seal groove 108 are formed in the external surface 104 of the tube by rolling means of manufacture. Each of the grooves is thereby formed in the external surface of the tube from the wall thereof.

Alternatively, referring to FIG. 6b, the retention groove 106 and the second seal groove 108 is formed in the external surface 104 of the tube by cutting means of manufacture. Each of the grooves is thereby formed in the external surface 104 of the tube within the wall thereof.

The retention groove 106 may be formed having steep or substantially vertical sides in order to enhance engagement of the groove 106 with the holding clamp 103. On the other hand the second seal groove 108 may be formed having shallower sides to facilitate accommodation of the O ring 110. However, this may not be essential for the working of the invention.

Referring to FIG. 7, a method of manufacturing the tube structure is shown whereby the retention groove 106 and the second seal groove 108 is formed from a rolling method of manufacture whereby groove forming wheels 114 are rolled over the external surface 104 of the tube to form the grooves, 106 and 108, therein.

Referring to FIG. 8, a second method of manufacturing the tube structure is shown whereby the retention groove 106 and the second seal groove 108 are formed in the external surface 104 of the tube by cutting the grooves in the wall thereof using cutting tools 116.

In the methods of manufacture described above, the retention groove and the second groove may advantageously be formed simultaneously by the same method and using the same tools.

Referring to FIG. 9, the tube retainer 100 is shown attached to a device 118 for fluid communication between the pipe end 107 and an input/output port 120 disposed in the device. The pipe 102 is engaged in the slot 112 of the holding clamp 103. The holding clamp 103 is attached to the device 118 by way of a threaded bolt 122 which is in communication with a threaded bore 124 located in the device 118 to hold the holding clamp to a surface 126 thereof, thereby retaining the pipe 102 relative thereto. It will appreciated by the reader that other methods of attaching the holding clamp 103 to the device 118 are equally applicable to the working of the invention.

1. A tube retainer comprising:
a tube having a retention groove formed in an external surface, adjacent an open end, of said tube, and
a holding clamp adapted to engage said retention groove.

2. A tube retainer as claimed in claim 1, wherein the retention groove is annular.

3. A tube retainer as claimed in claim 1 or 2, wherein the holding clamp is a flat plate having a slot formed therein for engaging the retention groove.

4. A tube retainer as claimed in claim 3, wherein the slot is open ended such that it is formed from the peripheral edge of the flat plate.

5. A tube retainer as claimed in claim 1, wherein the tube further comprises a second seal groove formed in the external surface thereof interposed between the retention groove and the open end of the tube, wherein the sealing groove is adapted to receive sealing means.

6. A tube retainer as claimed in claim 5, wherein the sealing means is an O-ring.

7. A tube retainer as claimed in any of the preceding claim 1, wherein said holding clamp is attached to a device, said device having an inlet/outlet port therein for receiving said tube.

8. A method of manufacturing a tube retainers claimed in claim 1, comprising the steps of:
providing a tube;
forming a retention groove in the external surface of said tube, adjacent the open end of said tube; and
providing a flat plate and forming a slot in said flat plate to form a clamping plate.

9. A method as claimed in claim 8, comprising a further step of:
forming a second seal groove in the external surface of the tube, said second seal groove being formed such that it is suitable for receiving sealing means.

10. A method as claimed in claim 9, whereby the second sealing groove is formed in the external surface of the tube between the retention groove and the adjacent open end of the tube.

11. A method as claimed in claim 8, whereby at least one of the retention groove and second seal groove is formed in the external surface by rolling a groove therein.

12. A method as claimed in claim 8, whereby at least one of the retention groove and second seal groove is formed in the external surface by cutting a groove therein.

13. A method of retaining a tube to engage a device comprising:
forming a retention groove adjacent to an end of the tube;
forming a slot in a holding clamp to engage said annular retention groove; and
attaching said holding clamp with the tube to the device.

14. A method as claimed in claim 12, whereby the retention groove is annular.

15. A method as claimed in claim 12, further comprising forming a second seal groove between said retention groove and said end of said tube for receiving sealing means.

16. A method as claimed in claim 8, wherein said slot extends from an aperture formed in said flat plate.

17. A method as claimed in claim 13, whereby the retention groove is annular.

18. A method as claimed in claim 13, further comprising:
forming a second seal groove between said retention groove and said end of said tube for receiving sealing means.
